(19) United States
(12) Patent Application Publication
(10) Pub. No.: US 2026/0283294 A1
(43) Pub. Date: Sep. 24, 2026

(54) Convertible Shoe and Method for Manufacturing a Convertible Shoe

(71) Applicant: Alexander Joist, Euskirchen (DE)

(72) Inventor: Alexander Joist, Euskirchen (DE)

(21) Appl. No.: 19/475,645

(22) PCT Filed: Apr. 17, 2024
(86) PCT No.: PCT/EP2024/060398

§ 371 Date: Oct. 15, 2025

(30) Foreign Application Priority Data
Apr. 21, 2023 (DE) 10 2023 110 262.1
Oct. 6, 2023 (EP) 23202216.0

(51) Int. Cl. A43B 3/24; B29D 35/00; B29D 35/06; B29D 35/12

(52) U.S. Cl. CPC A43B 3/244; B29D 35/0072; B29D 35/061; B29D 35/122; B29D 35/128

(57) ABSTRACT

A shoe (1) and a method for manufacturing a shoe are proposed, wherein the shoe has an upper part (11) which is connected to the sole (12) by means of a separable zipper (4) and is removable from the sole (12) by opening the zipper (4).

In order to be able to manufacture the shoe (1) inexpensively and yet in a mechanically robust design, it is proposed that the zipper (4) be connected to the sole (12) by injection-molding the sole (12) onto a part of the zipper (4) or by injection-molding the sole (12) around a part of the zipper (4).

The invention relates to a method for manufacturing a shoe according to the features of the preamble of claim 1.

From practice, two-part shoes are known with an upper part, also called a topper, that can be removed from the sole. For example, EP 2 134 204 B1 shows a shoe that has a removable upper part and a sole that are connected to each other by a zipper. The sole comprises a support plate to give the shoe the necessary stability. Manufacturing such a multi-part shoe is correspondingly complex and therefore cost-intensive.

A shoe with a removable upper part to convert the shoe from a sneaker into a ballerina is known from utility model DE 20 2009 010 097U1 . Here too, the upper part is attached via a removable zipper.

Furthermore, utility model DE 20 2019 000 298 U1 shows a convertible shoe in which the upper part is removably attached to the sole by means of a zipper. This utility model teaches that the shoe comprises a magnet in the heel area of the topper and of the sole to secure the zipper in the closed position.

With the two-part shoes known to date, it is necessary to glue the zipper to the sole in a separate production step. This makes the manufacturing of such a two-part shoe relatively complex and error-prone.

It is the object of the present invention to provide a method for manufacturing a shoe with an upper part which is removable from the sole by means of a zipper and which enables a mechanically robust shoe to be produced at low cost.

According to the invention, this object is achieved by a method for manufacturing a shoe with the features of claim 1.

According to the invention, a method for manufacturing a shoe is proposed, the shoe having an upper part which is connected to the sole by means of a separable zipper and can be removed from the sole by opening the zipper. It is essential here that the zipper is connected to the sole by the sole being injection-molded or cast onto a part of the zipper, or by the sole being injection-molded around a part of the zipper, or by the sole being cast around a part of the zipper.

By injection-molding the sole or casting the sole onto a part of the zipper, the zipper is already mechanically firmly bonded to the sole during the manufacturing process for producing the sole. According to the invention, an additional work step to connect the zipper to the sole is no longer necessary. In addition, the connection is mechanically very resistant and robust due to the injection-molding of the sole or casting the sole onto the zipper. This means that the shoe produced by this manufacturing method has high mechanical stability and a long lifetime. Preferably, injection-molding or casting the sole means that sole material is introduced in a liquid state, which then hardens to form a solid sole.

A further advantage of the manufacturing method according to the invention is that the visible part of the zipper is relatively small, since the majority of the zipper is overmolded by the sole and thus the finished shoe has a visually pleasing design. In addition, the zipper can be concealed by a bead formed on the sole and/or concealed by a flap formed on the upper part, so that the external appearance of the shoe manufactured according to the inventive method hardly differs from a conventional shoe with the sole firmly attached to the upper part.

As the zipper, in particular, a separable or divisible zipper can be used, which has two halves, each of which comprises a textile strip which carries a toothed bar or staples or closing elements. The closing elements or staples are connected or disconnected via a movable slider. The zipper can be separated into two halves by unhooking it. In particular, one half of the zipper is arranged on the sole and the other half of the zipper on the upper part. To connect the upper part to the sole, the zipper is threaded together and closed in the usual way by moving the slider. This connects the upper part of the shoe to the sole via the zipper. The zipper may be a metal zipper or a plastic zipper.

An advantage is that the upper part of the shoe, also known as topper or shoe upper, can be removed from the sole, for example to clean it or to clean the sole separately. Another advantage is that the sole can be easily replaced for repair purposes.

In a preferred embodiment it may be provided that a multi-part mold is used to manufacture the shoe, which comprises a last, a sole bottom part and at least one side part or a plurality of side parts, and wherein the sole bottom part, the side part or the side parts and the last together form a sole chamber, and wherein the last and/or the at least one side part or the plurality of side parts has or have a circumferential groove, and a toothed bar of the zipper is inserted into the circumferential groove in such a way that a textile strip of the zipper projects downwards into the sole chamber.

In particular, it may be provided that after insertion of the toothed bar of the zipper into the groove, the mold is closed and sole material is then injected or cast into the sole chamber and cured there, wherein the textile strip of the zipper is bonded to the sole material during curing of the sole material. In particular, injection of the sole material means inserting the sole material in liquid form under higher-than-normal pressure. Casting in the sole material means in particular inserting the sole material in liquid form under normal pressure.

The sole can be of different shapes. In particular, different soles may be provided that differ in their properties with regard to cushioning and/or sole tread. Preferably, the sole tread of the shoe may be shaped by the sole bottom part. The sole bottom part may have a tread that serves as a negative shape for the sole tread.

In an advantageous embodiment, it may be provided that the sole is interchangeable, in particular that different soles with a different sole tread are provided, which are interchangeable. This can change the character of the shoe, for example by providing a first sole with a rough sole tread and a second sole with a fine tread, for example a razor-cut tread or a sole with a smooth tread.

It may preferably be provided that the sole is constructed from different materials, wherein one of the different materials or several of the different materials are inserted into the sole chamber before the sole material is injected or cast in, or that several of the different materials are injected or cast into the sole chamber one after the other and cured there. For example, soles with different cushioning properties may be provided to create a customizable sports shoe. Depending on the materials used, the cushioning properties of the sole may be adjusted so that the shoe produced by the inventive method can be adapted individually to different scopes of application or types of sport.

Different materials may be used for the sole material. The decision for a particular type of material is preferably made on the basis of the desired cushioning properties of the sole. Various cushioning elements may also be incorporated into the sole to create a specific cushioning property. Different sole materials may be combined with each other. Furthermore, combinations of sole materials with leather outsoles or rubber outsoles are also provided.

For example, the following materials may be used for the sole material: PU-Mono (Polyurethane), PU-PU, PU-TPU (Thermoplastic Polyurethane), PU-TPE (thermoplastic elastomers), PU-rubber, PU-TR (thermoplastic rubber), PU leather, TPU, TPE-U (urethane-based thermoplastic elastomer), SEBS (styrene-ethylene-butylene-styrene), EVA (ethylene-vinyl acetate), EVA-TPU, EVA rubber, PVC (polyvinyl chloride), TPS (styrene block polymers). This listing is to be understood as an example and does not represent an exhaustive list or limitation of possible sole materials.

In a preferred embodiment, it may be provided that a foil is inserted into the sole chamber and/or that a foil is inserted between the last and the mold and that the foil is held in the mold by vacuum. The foil may be inserted into the sole chamber before the sole material is inserted. The foil may improve the quality and/or appearance of the sole, in particular contribute to the finish of the sole. The foil can be made of PU, TPU or PVC, for example.

In a preferred embodiment, it may be provided that the toothed bar of the zipper is held in the circumferential groove of the last and/or of the at least one side part or the several side parts by means of a vacuum. This has the advantage that the zipper is always arranged or held in the same position during the manufacturing process and remains in this position while the sole material is being inserted into the sole chamber. For example, it may be provided that the last has vacuum channels that extend up to the circumferential groove, in particular to hold the toothed bar of the zipper in the circumferential groove. Alternatively or additionally, it may also be provided that the side part and/or the multiple side parts comprises and/or comprise vacuum channels which extend up to the circumferential groove, in particular to hold the toothed bar of the zipper.

Preferably, the vacuum channels are designed in such a way that they extend through the last and/or through the side part or the several side parts up to the circumferential groove. The ends of the vacuum channels at the position of the circumferential groove are preferably designed in the form of bores or holes. Preferably, the bores or holes are spread over the entire length of the circumferential groove, in particular spread equidistantly. This ensures that the toothed bar is held securely in the groove over the entire length of the circumferential groove. It may also be provided that the vacuum channels are arranged on or connected to a vacuum unit. The vacuum unit preferably generates the negative pressure or vacuum to hold the toothed bar securely in the groove. A vacuum is preferably understood to be a pressure that is lower than the ambient pressure.

An advantage is that the sole layout, the sole design and the sole treads can be designed freely and may be varied according to the respective material properties of the sole material and the desired design within the scope of the craftsmanship of the skilled person.

In an embodiment it may be provided that a shoe upper is provided, which has a part of the separable zipper on its lower circumferential edge, and wherein the shoe is finished by connecting the shoe upper to the sole by closing the zipper.

Different shaft materials may be used for the upper part of the shoe, also called a topper or shoe upper. For example, knitted materials may be used or weaved materials or textiles, and/or leather, and/or synthetics, and/or polyurethane and/or PVC foils etc. may be used. A combination of these materials may also be used to form the upper part of the shoe.

The upper part of the zipper may be attached to the shoe upper or shaft by sewing or by high-frequency welding or by adhesion.

Advantageously, it may be provided that the shoe upper has a flap on its inner side, in particular a circumferential flap, in order to cover and/or cushion the toothed bar of the zipper. Alternatively or additionally, it may also be provided that the finished shoe has an insole which is designed in such a way that the edge of the insole covers the toothed bar of the zipper. Advantageously, a waterproof zipper may be used as the zipper. This also makes it possible to produce water-resistant or waterproof shoes.

Advantageously, it may be provided that a cap is sewn and/or welded and/or glued into the heel area of the shoe inside the upper part, wherein the cap is designed to cover the zipper. In particular, a cap made of plastic or similar materials may also be provided in the sole or in the area of the sole by means of pins or one or more magnets in order to cover the zipper.

Furthermore, the idea according to the invention also comprises a last for manufacturing a shoe, the shoe having an upper part which is connectable to the sole by means of a separable zipper and is removable from the sole by opening the zipper, in particular for manufacturing a shoe according to the method as described above. It is essential that the last has a circumferential groove on its lower circumference for inserting a toothed bar of the zipper.

The last can be made of various materials. The material for the last may, for example, be wood and/or metal (for example aluminum or steel), and/or plastic (for example HDPP or polyester resin or epoxy resin) or combinations thereof. The last may be produced by manufacturing the last by means of 3D printing or by lathe cutting the shape of the last or by milling the shape of the last. It is also possible to manufacture the last using a casting process.

It is further provided that the idea according to the invention also comprises a mold for manufacturing a shoe, wherein the shoe has an upper part which is connected to the sole by means of a separable zipper and is removable from the sole by opening the zipper, in particular for manufacturing a shoe according to the method described above. It is essential that the mold comprises a sole bottom part and one side part or more side parts, wherein the side part or the plurality of side parts laterally delimit the sole bottom part in order to form a sole chamber, and that either the side part or the side parts comprise a circumferential groove in order to insert a toothed bar of a zipper, and/or that a last is used as described above in order to receive a toothed bar of a zipper.

The side part or the side parts of the mold preferably form a mold ring. The mold ring encloses the sole bottom part and delimits it laterally. A groove is preferably incorporated in the mold ring, i.e. in the side part or side parts of the mold, in order to be able to insert the toothed bar of a zipper in such a way that the textile strip of the zipper projects into the sole chamber. This allows the sole material to be injected or cast into the closed sole mold so that the zipper is firmly connected to the sole after the sole material has cured.

The groove for inserting the toothed bar of a zipper can either be provided only in the last or either be provided only in the mold ring or one side part or multiple side parts of the mold or, in a further embodiment, be provided both in the last and in the mold ring, i.e. in one side part or in multiple side parts of the mold.

In particular, it may be provided that the groove is arranged at a constant distance from the surface of the sole bottom part of the sole, in particular as a closed circumferential groove.

In order to provide a sole with an improved finish, it may be provided that the side part and/or the side parts and/or the bottom part has and/or have vacuum channels, in particular to vent the sole chamber and/or to hold a foil. The foil may be inserted into the sole chamber and/or between the last and the side part or the bottom part of the mold before the sole material is inserted. The foil may then be held in the mold by vacuum. Subsequently, the sole material may be inserted and the sole may be cast.

In particular, the foil may be thermally deformed so that the foil fits particularly well to the multi-part mold, in particular to the sole bottom part and/or to the side part and/or the side parts, in particular under the simultaneous effect of a vacuum. The foil may be heated by heating the multi-part mold or by inserting heated sole material. By thermally deforming the foil, it is possible to achieve particularly good contact between the foil and the multi-part mold so that the inserted foil does not shift. The formation of wrinkles can also be prevented.

Advantageously, it may be provided that the bottom sole part and/or the side part or the side parts are movably mounted in such a way that they can be closed and opened in order to form a sole chamber together with a last, in particular a last as described above, in their closed position.

Further, the inventive idea also comprises a construction kit for a shoe, in particular a shoe manufactured in line with the manufacturing method according to one of the examples described herein, wherein the construction kit comprises at least one shoe upper and at least two different soles, and/or comprises at least one sole and at least two different shoe uppers, wherein the shoe can be manufactured by connecting one of the shoe uppers to one of the soles by means of a zipper.

For example, the construction kit for the shoe may be designed as a sales unit, so that in a store or shoe store the construction kit is offered as a set for the shoe produced by the inventive method, which comprises at least one upper part and at least two different soles, for example to adjust the character of the sole. Alternatively, the construction kit or set for manufacturing the shoe may also be provided by offering at least two shoe uppers and a sole in order to be able to individually customize the design of the shoe. Of course, the construction kit or sales unit may also be offered with a variable number and type of shoe uppers or soles to give a customer the opportunity to individually customize the shoe.

In particular it may be provided that the type of shoe and/or the design of the shoe can be changed by exchanging the sole for another sole and/or by exchanging the shoe upper for another shoe upper.

The drawings show exemplary embodiments of the manufacturing method according to the invention and of the shoe produced by the manufacturing method and are described in the following description of the drawings. They show:

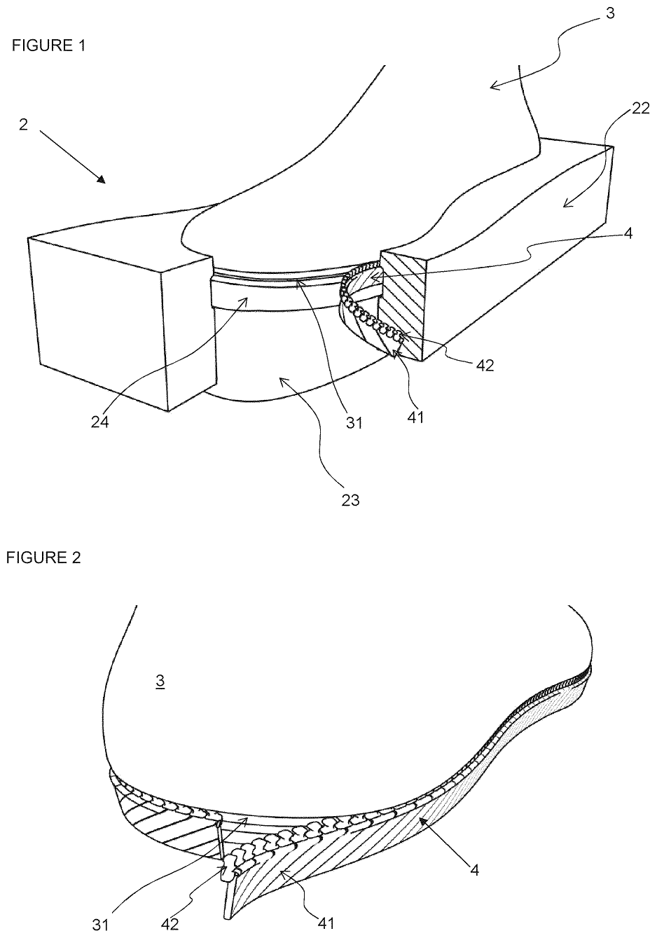

FIG. 1 a schematic 3D view of a device for carrying out the manufacturing method according to the invention;

FIG. 2 a schematic view of the method step of inserting the zipper into the groove of a last;

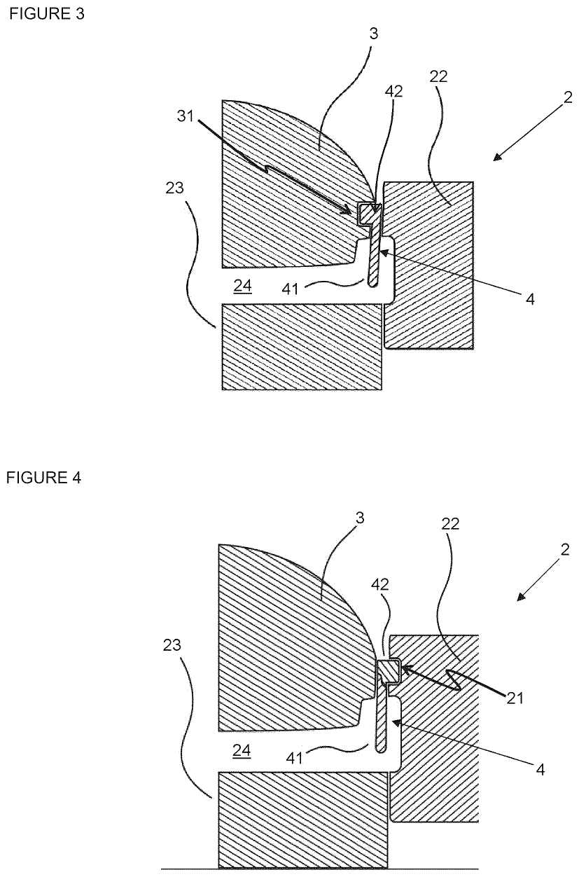

FIG. 3 a sectional view of a multi-part mold for carrying out the manufacturing method according to the invention;

FIG. 4 an alternative embodiment as shown in FIG. 3;

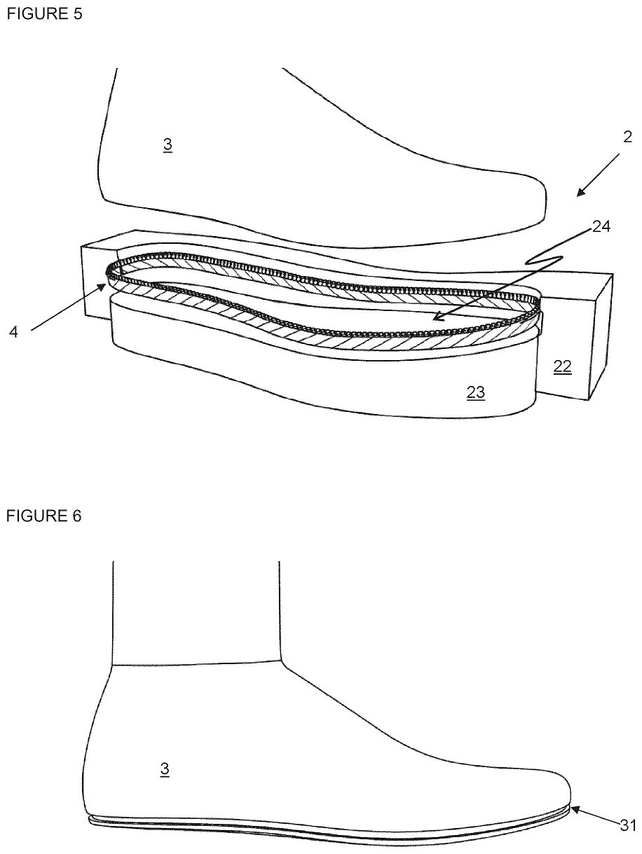

FIG. 5 a schematic exploded view of a multi-part mold for carrying out the method according to the invention;

FIG. 6 a last according to the invention;

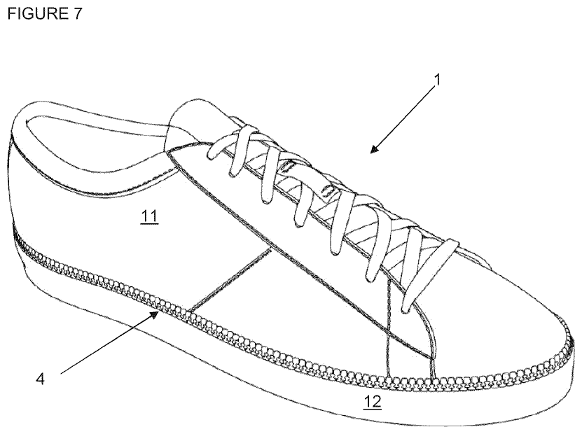

FIG. 7 a shoe manufactured using the inventive manufacturing method;

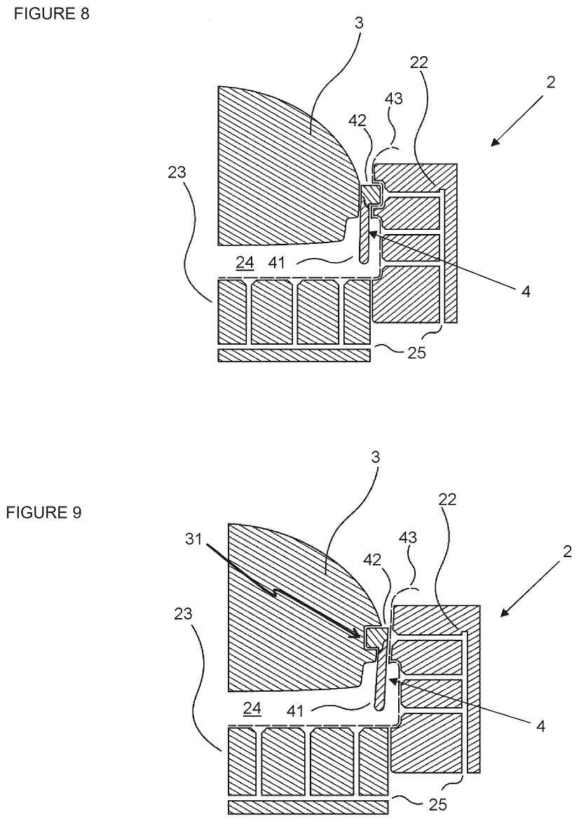

FIG. 8 a sectional view of an alternative embodiment of a multi-part mold for carrying out the manufacturing method according to the invention;

FIG. 9 a further modification of a multi-part mold for carrying out the manufacturing method according to the invention.

The drawings show various embodiments and examples for implementing the invention. These embodiments serve to explain the invention and should not be understood as limiting. It is clear to the skilled person that they can modify and vary the embodiments shown in the drawings within the scope provided by the claims without departing from the basic idea of the invention.

FIG. 1 shows a multi-part mold 2 for carrying out the inventive method for manufacturing a shoe 1. The multi-part mold 2 has a sole bottom part 23, which is laterally delimited by side parts 22. A last 3 is arranged on the top of the multi-part mold 2. The parts of the multi-part mold 2 together enclose a sole chamber 24. The last 3 has a circumferential groove 31 into which a zipper 4 is inserted.

FIG. 2 shows a detailed enlargement of the last 3 with groove 31. FIG. 2 also shows how the zipper 4 is inserted into the groove. The zipper 4 has a textile strip 41 on which the closing elements are held in the form of staples 42. The groove 31 of the last 3 is designed such that it receives the closing elements or staples 42 of the zipper in such a way that the textile strip 41 of the zipper projects downwards into the sole chamber 24.

FIG. 3 shows a section of the multi-part mold 2. The section shows the last 3, which closes the sole chamber 24 at the top and has a groove 31 into which the zipper 4 is inserted. The textile strip 41 of the zipper 4 projects downwards into the sole chamber 24. The closing elements 42 of the zipper 4 are received by the groove 31 of the last 3. The side part 22 closes the last and the sole bottom part 23 laterally.

The sole bottom part 23 is arranged below the sole chamber 24 and forms the bottom of the sole chamber 24.

The embodiment of the multi-part mold 2 in FIG. 4 corresponds to the embodiment of FIG. 3, with the difference that the groove 21 for inserting the zipper 4 is not arranged in the last 3, but in the side part 22. Besides, the embodiment of FIG. 4 corresponds to the embodiment of FIG. 3.

Alternatively, embodiments are also possible in which both the last 3 has a groove 31 and the side part 22 has a groove 21 in order to receive the closing elements 42 of the zipper 4.

FIG. 5 shows a perspective view of the multi-part device 2. It can be seen here that the side part 22 laterally delimits the sole bottom part and the last 3 is placed from above in order to close all sides of the sole chamber 24.

It is provided that individual parts of the multi-part mold 2 are movably mounted so that the mold 2 can be opened and closed. In its closed position with the zipper 4 inserted, it is provided that the sole 12 of the shoe 1 to be manufactured is formed by injecting or casting sole material into the sole chamber 24. The sole material then cures and bonds with the zipper 4 in such a way that it is inseparably connected to the manufactured sole 12.

FIG. 6 shows an example of a last 3. The last may be made of a solid material such as metal or aluminum or plastic, for example. The last 3 has a groove 31 on its lower circumferential edge. The groove 31 is formed in a closed circumferential manner around the last 3. The toothed bar 42 of a zipper 4 may be inserted into the groove 31 in order to subsequently bond it to the sole 12 in the multi-part mold 2 by means of direct injection or a casting process.

FIG. 7 shows a shoe 1 manufactured according to the inventive manufacturing method. The shoe 1 has an upper part 11 and a sole 12. The upper part 11 is connected to the sole 12 via the zipper 4. By opening and separating the zipper 4, the upper part 11 may be removed and replaced with another upper part. It is also possible to leave the upper part 11 in place and replace the sole 12 instead. This makes it easy to adjust the shoe to different requirements. For example, the shoe upper 11 may be replaced for design reasons in order to change the external appearance of the shoe. The sole 12 may also be exchanged, for example to convert a sports shoe from an indoor sports shoe into an outdoor sports shoe by exchanging an indoor sole 12 for an outdoor sole 12. It is also possible to replace a plastic sole 12 with a leather sole 12 and connect it to the upper part 11. For this purpose, it may be provided that a corresponding plastic layer is arranged on the upper side of the leather sole, which is connected to the zipper 4 in the multi-part mold 2 by injection molding or casting. This also makes it possible to add a leather sole to a sports shoe or sneaker, for example, to give the shoe a more formal look.

It is also possible to replace the sole 12 with a new sole in the event of a defect, allowing the shoe to be repaired in an instant. The shoe upper 11 or topper 11 may also be replaced in the same way if it is defective. This means that the shoe produced with the manufacturing method according to the invention may be repaired easily, thus saving resources and costs.

FIG. 8 shows an embodiment of the multi-part mold 2. The multi-part mold 2 is constructed in the same way as the multi-part mold shown in FIG. 4. The multi-part mold 2 has a sole chamber 24, which is delimited by the last 3 arranged at the top, the side parts 22 and the sole part 23. The side part 22 has a groove into which a zipper is inserted. The textile strip 41 of the zipper 4 projects downwards into the sole chamber 24. The closing elements 42 of the zipper 4 are received by the groove in the side part 22. In contrast to the embodiments of FIG. 3 and FIG. 4, the side part 22 and the sole part 23 have vacuum channels 25. The vacuum channels 25 may be used to generate a vacuum in the sole chamber 24 or to vent the sole chamber 24.

To produce the shoe, a foil 43 is inserted between the last 3 and the mold 2, i.e. between the side part 22 and the sole part 23. The foil may be held by means of a vacuum. The advantage of the foil is that it simplifies the manufacturing process. The foil may, for example, help to obtain a self-contained sole surface or to improve the finish of the sole.

FIG. 9 shows an alternative embodiment of the multi-part mold 2. In contrast to the embodiment of FIG. 8, the last 3 here has the groove 31 into which the closing elements 42 of the zipper 4 are inserted. The foil 43 is inserted between the last 3 and the side part 22 or sole part 23 as shown in FIG. 8. Here again, the foil 43 is held or fixed to the side part 22 and the sole part 23 by vacuum, which is introduced via the vacuum channels 25. After inserting the foil 43, the sole material is inserted into the sole chamber 24 and cured.

In a modification to the embodiments of FIGS. 8 and 9, it is of course also possible to create a multi-part mold in which both the last 3 and the side part 22 have a groove, such that the closing elements 42 of the zipper 4 are received both in the groove of the last and in the groove of the side part 22. Here, it is also possible that a foil 43 is inserted between the last 3 and the side part 22 or the sole part 23 and held in place by vacuum to improve the finish or the surface of the sole.

### LIST OF REFERENCE SIGNS

1 Shoe
11 Upper part, topper
12 Sole
2 Mold
21 Groove
22 Side part
23 Sole bottom part
24 Sole chamber
25 Vacuum channels
3 Last
31 Groove
4 Zipper
41 Textile strip
42 Staples
43 Foil

1. A method for manufacturing a shoe, the shoe having an upper part which is connected to the sole a separable zipper and which can be removed from the sole by opening the zipper,
comprising:
connecting the zipper to the sole by one of the sole being injection-molded onto a part of the zipper, the sole being cast onto a part of the zipper, the sole being injection-molded around a part of the zipper, or the sole being cast around a part of the zipper.

2. The method for manufacturing a shoe according to claim 1,
wherein
a multi-part mold is used to manufacture the shoe, the multi-part mold comprising a last, a sole bottom part and one or more of side parts, wherein the sole bottom part, the one or more side parts and the last together form a sole chamber, and wherein at least one of the last or the one or more side parts has a circumferential groove, and a toothed bar of the zipper is inserted into the circumferential groove in such a way that a textile strip of the zipper projects downwards into the sole chamber.

3. The method for manufacturing a shoe according to claim 2,
wherein
after insertion of the toothed bar of the zipper into the groove, the mold is closed and sole material is then injected or cast into the sole chamber and cured there, wherein the textile strip of the zipper is bonded to the sole material during curing of the sole material.

4. The method for manufacturing a shoe according to claim 2,
wherein
the sole is constructed from different materials, wherein one or more of the different materials are introduced into the sole chamber.

5. The method for manufacturing a shoe according to claim 2,
wherein
a foil is inserted into the sole chamber between the last and the mold, and wherein the foil is held in the mold by vacuum.

6. The method for manufacturing a shoe according to claim 2,
wherein
the toothed bar of the zipper is held in the circumferential groove of one or more of the last or the one or more side parts by-means vacuum.

7. The method for manufacturing a shoe according to claim 1,
wherein
a shoe upper is provided, which has a part of the separable zipper on its lower circumferential edge, and wherein the shoe is finished by connecting the shoe upper to the sole by closing the zipper.

8. The method for manufacturing a shoe according to claim 7,
wherein
the shoe upper has a flap on its inner side, in particular a circumferential flap, in order to perform one or more of covering or cushioning the toothed bar of the zipper.

9. The method for manufacturing a shoe according to claim 1,
wherein
a waterproof zipper or a water-repellent zipper is used as the zipper.

10. A method for manufacturing a shoe, the shoe having an upper part which is connectable to the sole by means of a separable zipper and is removable from the sole by opening the zipper.
comprising:
providing a last having a circumferential groove on its lower circumference; and inserting a toothed bar of the zipper into the circumferential groove.

11. The method for manufacturing a shoe according to claim 10,
wherein
the last comprises vacuum channels which extend up to the circumferential groove to hold the toothed bar of the zipper in the circumferential groove.

12. A method for manufacturing a shoe, wherein the shoe comprises an upper part which is connected to the sole by a separable zipper and which is removable from the sole by opening the zipper.
comprising:
using mold that comprises a sole bottom part and one or more side parts, the one or more side parts laterally delimiting the sole bottom part in order to form a sole chamber together with a last, and wherein at least one of the last or the one or more side parts has circumferential groove to receive a toothed bar of the zipper.

13. The method for manufacturing a shoe according to claim 12,
wherein
the circumferential groove is arranged at a constant distance from the surface of the sole bottom part and, is designed as a closed circumferential groove.

14. The method for manufacturing a shoe according to claim 12,
wherein
at least of the one or more side parts the bottom part comprises vacuum channels for at least one of venting the sole chamber or holding a foil.

15. The method for manufacturing a shoe according to claim 12,
wherein
the one or more side part comprises vacuum channels which extend up to the circumferential groove, to hold the toothed bar of the zipper.

16. The method for manufacturing a shoe according to claim 12,
wherein
at least one of the sole bottom part or the one or more side parts are movably mounted in such a way that they can be positioned to form, with the last, the sole chamber.

17. A construction kit for manufacturing a shoe comprising: at least one of (i) one or more shoe upper and at least two different soles or (ii) one or more sole and at least two different shoe uppers, wherein the shoe can be manufactured by connecting one of the shoe uppers to one of the soles a zipper.

18. The construction kit for a shoe according to claim 17,
wherein
at least one of type of the shoe design of the shoe can be changed by exchanging the sole for another sole or by exchanging the shoe upper for another shoe upper.
